(19) United States
(12) Patent Application Publication
(10) Pub. No.: US 2003/0038694 A1
(43) Pub. Date: Feb. 27, 2003

(54) Electromagnetic switcing device, especially contactor, with a contact bridge support lock

(76) Inventors: Johann Bauer, Ebermannsdorf (DE); Stephan Faber, Kuemmersbruck (DE); Bardo Koppmann, Kaltenbrunn (DE)

Correspondence Address: HARNESS, DICKEY & PIERCE, P.L.C., P.O.BOX 8910, RESTON, VA, 20195, US

(21) Appl. No.: 10/221,782

(22) PCT Filed: Mar. 5, 2001
(86) PCT No.: PCT/DE01/00830

(30) Foreign Application Priority Data
Mar. 17, 2000 (DE) 100 13 319.3

(51) Int. Cl. H01H 67/02

(52) U.S. Cl. 335/132

(57) ABSTRACT

The invention relates to an electromagnetic switching device, especially a contactor, comprising a base (1), an arc chamber (2) removable from the base (1), a contact bridge support (4) and a spring-loaded locking element (5). The contact bridge support (4) projects into the arc chamber (2) and can be displaced in a direction of actuation (x). The contact bridge support can be locked by means of the locking element (5) when the arc chamber (2) is taken off. The locking element (5) is configured as a lever that is swiveled about a swiveling axis (10) which extends in perpendicular to the direction of actuation (x).

The present invention relates to an electromagnetic switching device, in particular a contactor, having a lower part, an arcing chamber which can be removed from the lower part, a contact link support and a spring-loaded blocking element, in which the contact link support is held in the lower part, projects into the arcing chamber and can be moved in an operating direction, in which the contact link support can be locked by means of the blocking element when the arcing chamber is removed, in which the blocking element is held in the lower part and is in the form of a lever which can pivot about a pivoting axis.

A switching device such as this is known, for example, from DE 43 41 330 C1. The known switching device already operates quite well, but the blocking element requires a relatively large amount of space.

A similar electromagnetic switching device is known from DE 34 02 836 A1. In this switching device, the blocking element is mounted in the contact link support.

An electromagnetic switching device is known from DE 195 47 011 C1, in which the contact link support can be locked in its connected position by means of a lever which can pivot, in which case the lever can pivot about a pivoting axis which runs at right angles to the operating direction of the contact link support.

The object of the present invention is to further develop a switching device such that it is more compact.

The object is achieved in that the pivoting axis runs at right angles to the operating direction.

If the pivoting element is guided in a bush bearing during pivoting, the blocking element bearing is particularly simple.

If the blocking element is held in a captive manner in the lower part, the switching device is particularly reliable in operation. The captive retention can be provided, for example, by the blocking element and the lower part having latching elements which interact in order to hold the blocking element in the lower part, in which case at least one of the latching elements can be deflected in a sprung manner in the direction of the pivoting axis.

If the blocking element interacts with the contact link support in a locking region, and has a ramp incline in the locking region, the contact link support can be configured as required without there being any risk of it undesirably remaining stuck in position before reaching the locked position.

If the blocking element is manually accessible and can be operated manually when the arcing chamber is removed, it is particularly simple to test the switching device for correct operation.

The test is even simpler if, apart from the blocking element, the switching device has no further blocking element for locking the contact link support.

Further advantages and details can be found in the following description of an exemplary embodiment. In this case, illustrated in outline form:

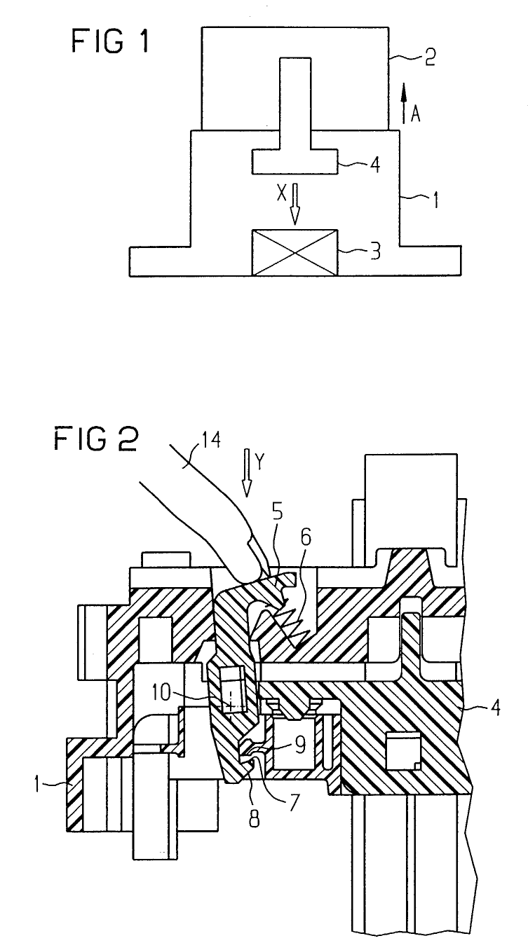

FIG. 1 shows a contactor,

FIG. 2 shows a detail from FIG. 1, and

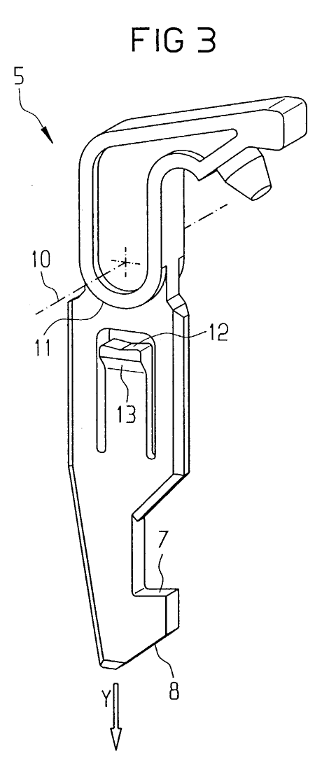

FIG. 3 shows a blocking element.

As shown in FIG. 1, a contactor, as an example of an electromagnetic switching device, has a lower part 1 and an arcing chamber 2. As is indicated by an arrow A in FIG. 1, the arcing chamber 2 can be removed from the lower part 1.

A drive coil 3 is arranged in the lower part 1. When a switching current is applied to the drive coil 3, a contact link support 4 is moved in an operating direction x. The contact link support 4 is mounted in the lower part 1, and projects into the arc chamber 2.

As shown in FIG. 2, the contactor furthermore has a blocking element 5, which is spring-loaded by means of a spring 6. As shown in FIG. 2, the spring 6 is in the form of a compression spring. However, in principle, the spring 6 could also be in the form of a tension spring or rotary spring.

When the arcing chamber 2 is removed, the contact link support 4 can be locked with the contactor in the disconnected position, by means of the blocking element 5. For this purpose, the blocking element 5 interacts with the contact link support 4 in a locking region 7. The locking region 7 is in the form of a hook and has a ramp incline 8 at its lower end. The hook-shaped locking region 7 of the blocking element 5 engages in a corresponding mating contour 9 on the contact link support 4, thus locking the contact link support 4.

As shown in FIG. 2, the blocking element 5 is in the form of a lever which can pivot about a pivoting axis 10. The pivoting axis 10 in this case runs at right angles to the operating direction x and has a semicircular bearing point 11, which can be mounted in a corresponding bearing bush in the lower part 1. The blocking element 5 is thus guided in a bush bearing 11 during pivoting.

As shown in FIG. 3, the blocking element 5 also has a latching element 12. The latching element 12 can be deflected in a sprung manner in the direction of the pivoting axis 10. The latching element 12 interacts with a further latching element, which is arranged in the lower part 1. The further latching element may, but need not necessarily, be capable of being deflected in a sprung manner in the direction of the pivoting axis 10. The interaction of the latching elements 12 results in the blocking element 5 being held in a captive manner in the lower part 1.

The latching element 12 also has a ramp incline 13. The blocking element 5 can thus be inserted in the lower part 1 simply by pushing it into the lower part 1 in the insertion direction y.

The process of fitting the arcing chamber 2 to the lower part 1 necessarily and automatically results in the contact link support 4 being unlocked. As is indicated schematically by a finger 14 in FIG. 2, the blocking element 5 is, however, also manually accessible and can be operated manually when the arcing chamber 2 is removed. It is thus possible to unlock the contact link support 4 when the arcing chamber 2 has been removed, and then to test the contactor for correct operation. The ramp incline 8 ensures that, when the contact link support 4 is moved back to the disconnected position of the contactor, it is impossible for the contact link support 4 to be hooked to the blocking element 5 before reaching the disconnected position.

In principle, it is possible to provide a number of blocking elements 5 (in particular arranged in symmetrically distributed manner). However, in particular, the test becomes especially simple once the arcing chamber 2 has been removed if the contactor has only a single blocking element 5, that is to say it has no further blocking element for locking the contact link support 4.

1. An electromagnetic switching device, in particular a contactor, having a lower part (1), an arcing chamber (2) which can be removed from the lower part (1), a contact link support (4) and a spring-loaded blocking element (5),
in which the contact link support (4) is held in the lower part (1), projects into the arcing chamber (2) and can be moved in an operating direction (x),
in which the contact link support (4) can be locked by means of the blocking element (5) when the arcing chamber (2) is removed,
in which the blocking element (5) is held in the lower part (1) and is in the form of a lever which can pivot about a pivoting axis (10),
characterized in that the pivoting axis (10) runs at right angles to the operating direction (x).

2. The switching device as claimed in claim 1,
characterized in that the blocking element (5) is guided in a bush bearing (11) during pivoting.

3. The switching device as claimed in claim 1 or 2,
characterized in that the blocking element (5) is held in a captive manner in the lower part (1).

4. The switching device as claimed in claim 3,
characterized in that the blocking element (5) and the lower part (1) have latching elements (12) which interact in order to hold the blocking element (5) in the lower part (1), in which at least one of the latching elements (12) can be deflected in a sprung manner in the direction of the pivoting axis (10).

5. The switching device as claimed in one of the preceding claims,
characterized in that the blocking element (5) interacts with the contact link support (4) in a locking region (7), and in that the blocking element (5) has a ramp incline (8) in the locking region (7).

6. The switching device as claimed in one of the preceding claims,
characterized in that, when the arcing chamber (2) is removed, the blocking element (5) is manually accessible and can be operated manually.

7. The switching device as claimed in one of the preceding claims,
characterized in that, apart from the blocking element (5), the switching device has no other blocking element for locking the contact link support (4).
